(19) United States
(12) Patent Application Publication
(10) Pub. No.: US 2015/0045498 A1
(43) Pub. Date: Feb. 12, 2015

(54) METHOD FOR PRODUCING A SURFACE - FUNCTIONALISED OBJECT

(71) Applicants: Jas Pal S. Badyal, Wolsingham (GB); Hayley G. Andrews, Durham (GB)

(72) Inventors: Jas Pal S. Badyal, Wolsingham (GB); Hayley G. Andrews, Durham (GB)

(21) Appl. No.: 14/233,032

(22) PCT Filed: Jul. 18, 2012
(86) PCT No.: PCT/GB2012/051708

§ 371 Date: Sep. 24, 2014

(30) Foreign Application Priority Data
Jul. 20, 2011 (GB) 1112447.6

(51) Int. Cl. B29C 37/00; B29C 33/56

(52) U.S. Cl. CPC B29C 37/0032; B29C 33/56; B29K 2033/04
USPC 524/544; 264/485; 264/488; 264/496; 264/220; 264/338; 425/404

(57) ABSTRACT

A method for producing a surface-functionalised object involves: (i) providing negative mould (2) with a surface topography complementary to that desired on the object; (ii) applying a functional entity (20) to the mould surface, in an exciting medium; (iii) forming the object (21) in or on the mould (2), the object being in direct contact, as it forms, with the functional entity (20); and (iv) releasing the object (21) from the mould, wherein during steps (iii) and/or (iv), at least some (22) of the functional entity (20) is transferred from the mould to the object, whilst a proportion remains on the mould (2) surface. The method can be used to functionalise the surface of an object as it is cast, and the mould can be re-used to form multiple replicate objects. The invention also provides an object produced using the method, and a surface-functionalised negative mould for use in the method.

### FIELD OF THE INVENTION

This invention relates to methods for producing surface-functionalised objects from negative moulds, and to objects produced using such methods.

### BACKGROUND TO THE INVENTION

When producing an object with a desired surface topography, it is known to form the object in or on a “negative” mould which has a topography complementary to that required in the end product (the so-called “positive replica”). Often the material from which the object is formed will be a polymer, which is cured when in contact with the mould.

It may also be desired to chemically functionalise the surface of the object. This is typically achieved, after the object has been released from the mould, by applying to the object's surface a coating of a suitable functional material, for example a water- or oil-repellent compound. The functional coating can be applied using known techniques such as spray coating, dipping or plasmachemical deposition.

Alternatively, the surface of the object can be functionalised by inducing chemical changes in the molecules which are present there, for example by reacting them with a functional reagent and/or by exposing them to conditions which initiate the necessary change.

One field in which it can be desirable to produce surfaces with a specific topography, and moreover with specific functional characteristics, is that of biomimetics. It is well established that the surface structures of species found in nature can lead to specific behavioural phenomena. Examples include the self-cleaning of plant leaves [1, 2], the adhesion of gecko feet [3, 4], the fog harvesting capacity of the Stenocara sp. beetle's back [5], the anti-reflective nature of insect wings [6] and the drag reducing effect of sharkskin [7]. Biomimetics research aims to identify such properties and to replicate them artificially.

A major element of work undertaken in this field has focused on the replication of the “superhydrophobicity” observed in certain naturally occurring systems. The best known examples of such systems are plant leaves (in particular the Nelumbo nucifera (Lotus) leaf), insect wings [8, 9], bird feathers [10], water strider legs [11, 12, 13] and biofilms [14]. Many of these possess a hierarchical surface structure consisting of micro- and nanoscale features, together with an inherently low surface energy. The roughness allows the trapping of tiny air pockets at the solid-liquid interface, thereby reducing adhesion between the surface and incident water droplets to allow them to roll off, a phenomenon which is known as a Cassie-Baxter wetting state [15]. Such superhydrophobic surfaces are of interest for the artificial production of surfaces having self-cleaning [16], low friction [17], anti-fog [18], anti-reflective [19] and anti-corrosive [20] properties.

A variety of approaches have been developed to provide hierarchically roughened structures on substrate surfaces akin to those observed in nature. Examples include photon [21] and electron beam [22] lithography, reactive ion etching [23] and micromachining [24]. Soft moulding is considered to be a simple, low cost alternative which offers the added advantage that the original natural substrate serves as a template for a master mould, in which an object having the desired surface topography can then be cast [25]. This biomimetic replication technique gives rise to precise and direct duplication of the parent substrate surface morphology.

However, in order to produce a truly superhydrophobic surface (defined as a surface exhibiting a contact angle greater than 150° combined with a very low hysteresis [26]), it is usually necessary to impart a further low surface energy finish to the replica. Such a finish can be achieved using functional chemicals such as fluorinated moieties, which in principle can be applied after the replica has been removed from the mould, using any of a range of methods such as sol-gel [27], self-assembled monolayers [28] and dip coating [29].

It is an aim of the present invention to provide alternative methods for producing objects having desired surface properties (in particular topography and chemical functionality), which methods can in cases enhance the ease and/or efficiency with which such surfaces can be produced.

### STATEMENTS OF THE INVENTION

According to a first aspect of the present invention there is provided a method for producing a surface-functionalised object from a mould, the method involving:
(i) providing a negative mould with a surface topography complementary to that desired on the object;
(ii) applying a functional entity to the surface of the negative mould, using a deposition process which takes place in an exciting medium;
(iii) forming the object in or on the negative mould, the object being in direct contact, as it forms, with the functional entity at the mould surface; and
(iv) releasing the object from the mould,
   wherein during steps (iii) and/or (iv), at least some of the functional entity is transferred from the surface of the mould to the surface of the object, and further wherein a proportion of the functional entity remains on the mould surface following release of the object in step (iv).

The object may be formed in or on the negative mould by a range of techniques, including for example casting, embossing and imprinting. Formation of the object will involve the formation, at a surface of the object, of a desired surface topography, complementary to that of the mould.

In an embodiment, the object is cast in or on the mould, from a castable material, for example from a curable material such as a polymer precursor.

The material from which the object is formed, and the functional entity, should be such that as the object forms against the mould, at least some of the functional entity can be transferred from the surface of the mould to that of the object. Typically, a layer of the functional entity is transferred. This layer—which may be a thin layer such as a monolayer or at least a nanolayer—remains at the surface of the object on its release from the mould. In cases, a quantity of the functional entity may penetrate and/or react with the material from which the object is made, at the relevant object surface.

Thus, the object forming and releasing steps (iii) and (iv) involve transferring at least some of the functional entity from the mould to the object. In an embodiment, this transfer may be “cure-activated”, ie it will occur during curing of a polymer precursor which is introduced into the mould in order to cast the object.

In order for this transfer to occur, the material from which the object is made should, within the mould, be in direct contact with the functional entity at the mould surface. Transfer of the functional entity can then be achieved directly from the negative mould, without the need for additional mould surface coatings such as release layers or adhesive layers. Thus, in an embodiment of the invention, only a single coating layer need be applied to the surface of the negative mould, that being a layer of the functional entity applied during step (ii). Suitably only a single coating layer is transferred from the mould surface to the object formed in step (iii), that being a layer of the functional entity. Suitably the method does not involve the application to the mould of, and/or the transfer to the object of, an additional layer such as a release layer, a primer layer, a top coat layer and/or an adhesive layer. Suitably it does not involve the application of such an additional layer to the mould other than by using an exciting medium (for example a plasma) as described below.

The transfer of at least some of the functional entity can remove the need to functionalise the object post-moulding, since it is functionalised as it is formed within the mould. In particular for the production of complex, fragile and/or chemically sensitive objects, the avoidance of a subsequent surface-functionalisation step can provide significant benefits, for example improved ease of handling, reduced product loss or damage, increased throughput and/or reduced costs.

According to the invention, therefore, template replication and surface functionalisation can be combined into a single step by a cure-activated film transfer. Such a method can be used, inter alia, to fabricate functionalised biomimetic surfaces.

A further advantage of the invention can be that cure-activated film transfer can result in a very thin functional layer on the surface of the object, which can improve the degree of correspondence between the object surface topography and that of the original template.

Moreover, in accordance with the invention, only a proportion of the functional entity—for example a thin layer—is transferred to the object. This leaves a further proportion (suitably at least a monolayer) of the functional entity on the mould surface, allowing the mould to be used again to form one or more further objects. Each time an object is formed in or on the mould, a quantity of the functional entity may be transferred to it. This can allow for the production of more than one, typically many, replicate objects in succession from the same negative mould, without the need to re-apply the functional entity to the mould surface each time, or at least reducing the frequency with which the functional entity needs to be applied.

Thus, in an embodiment of the first aspect of the invention, steps (iii) and (iv) are repeated more than once, for example more than twice, in succession. They may be repeated 5 or more times, or 8 or more times, or even 10 or more times, in succession. Suitably, step (ii), ie the application of a functional entity to the surface of the negative mould, is not repeated between the two or more successive repetitions of steps (iii) and (iv). Thus, a first quantity of the functional entity may be applied to the mould surface, following which a plurality of objects may be formed in, and released from, the mould, each taking with it a proportion of the first quantity of the functional entity. Subsequently, a further quantity of the functional entity may be applied to the surface of the mould, in order further to prolong its usability.

Without wishing to be bound by this theory, it is believed that a functional entity which is applied as a coating to the mould surface using an exciting medium such as a plasma, and in particular which is in polymeric form, can be designed so as to undergo a degree of delamination within the applied coating. In other words, the interactions between the molecules of the functional entity may be less strong than those between the functional entity and either the mould surface or the material from which the item is formed.

The negative mould, or at least a surface thereof, may be produced from a template surface having the topography which it is desired to replicate on the object being produced. In an embodiment, the template surface is a natural surface, such as an outer—or in cases inner—surface of a plant or animal or part thereof. Examples include plant leaves, insect wings, animal (including human) skins, organs, marine organisms and parts thereof, biofilms such as bacterial and fungal biofilms, surface coverings such as leaf surface waxes, exoskeletons, and materials produced by plants or animals (for example beeswax). In the present context, “plant or animal” embraces micro-organisms such as bacteria and fungi.

In an alternative embodiment, the template surface is a synthetic surface.

The negative mould may be produced from a solid template surface, or in some cases from a liquid or liquid-like surface such as a bio film or low molecular weight wax.

The negative mould may be prepared by any suitable means. In an embodiment, it is prepared by applying a layer of a suitable mould-forming material onto the template surface. The mould-forming material may comprise a polymer, suitably a low adhesion polymer. It may for example comprise a polysiloxane, and/or a vinyl polymer, such as a vinylsiloxane polymer. Other suitable mould-forming materials may include cements and plasters (for example plaster of Paris).

If necessary, production of the negative mould may involve curing a mould-forming precursor material such as a monomer precursor. In an embodiment, a mixture of a mould-forming precursor material (typically a monomer or monomer mixture) and a curing agent may be applied to the template surface. Such a mixture may for example comprise a polyvinylsiloxane base and cure mixture.

In an embodiment, production of the negative mould may involve depositing a suitable mould-forming material onto the template surface by a deposition technique such as plasma deposition, thermal chemical vapour deposition, initiated chemical vapour deposition (iCVD), photodeposition or ion-assisted deposition, in particular plasma deposition. Other suitable techniques for depositing the mould-forming material on the template surface include electron beam polymerisation, gamma-ray polymerisation, solution dipping, spraying, spin-coating from solution, and target sputtering.

The functional entity may be any chemical entity comprising a functional component. In an embodiment, the functional entity comprises a hydrophobic or oleophobic, in particular hydrophobic, component. In an embodiment, it acts to lower the surface energy of the object surface. Other functionalities which the functional entity may impart to the object surface include hydrophilicity, oil repellency, liquid repellency generally, increased or reduced permeability to liquids and/or gases, bioactivity, colour, detectability (eg through labeled moieties such as dyes or fluorescent tags), increased or reduced chemical or biochemical reactivity, increased or reduced adhesion (including, for example, reduced adhesion to the mould surface), lubricity, protein resistance, specific binding affinity, antifouling properties, antimicrobial activity, catalytic activity, conductivity (for example electrical and/or ionic conductivity), the addition of guest-host complexes or other forms of encapsulating entities (for instance for use in drug delivery), the addition of sensors, and combinations thereof. The functional entity may render the object surface suitable for use as a substrate for other materials and/or processes, for example as a substrate for tissue engineering or cell culture.

In a specific embodiment, the functional entity imparts to the object surface a property selected from liquid repellency (which may for example be water repellency or oil repellency), hydrophilicity, increased or reduced permeability to liquids and/or gases, bioactivity, increased or reduced chemical or biochemical reactivity, increased or reduced adhesion, lubricity, protein resistance, specific binding affinity, antifouling properties, antimicrobial activity, catalytic activity, conductivity, the addition of guest-host complexes or other forms of encapsulating entities, the addition of sensors, and combinations thereof.

More particularly, the functional entity may impart to the object surface a property selected from liquid repellency, hydrophilicity, increased or reduced permeability to liquids and/or gases, antifouling properties, and combinations thereof.

In an embodiment of the invention, it may be preferred for the functional entity not to be a paint, dye, stain or other form of colourant. In an embodiment, it may be preferred for the functional entity not to be coated onto the mould surface in the form of a loose powder: rather, it is preferred that the functional entity interacts with the mould surface, for instance at the molecular level.

The functional entity may for example comprise one or more functional groups selected from hydroxyl, carboxylic acid, anhydride, epoxide, furfuryl, amine, cyano, halide and thiol groups.

In an embodiment, the functional entity is a polymer, for example a polyacrylate, in particular a poly(alkyl acrylate). In an embodiment it is a halogenated (for example fluorinated) compound. It may be a halogenated, in particular fluorinated, polymer. In an embodiment, it is a halogenated, in particular fluorinated, polyacrylate, such as a poly(1H,1H,2H,2H-perfluorooctyl acrylate). In an embodiment, it is a polyelectrolyte. In an embodiment, it is a low tensile strength polymer.

In an alternative embodiment, the functional entity is a non-polymeric compound, which may be organic or inorganic. It may comprise a metallic component. It may comprise graphene. In an embodiment, it may be preferred for the functional entity not to be an oxide.

In an embodiment, the functional entity is a surfactant.

The functional entity is applied to the mould surface in an exciting medium. The exciting medium may for instance be generated using a hot filament, ultraviolet radiation, gamma radiation, ion irradiation, an electron beam, laser radiation, infrared radiation, microwave radiation, or any combination thereof. In general terms it may be created using a flux of electromagnetic radiation, and/or a flux of ionised particles and/or radicals. In a specific embodiment, the exciting medium is a plasma.

The functional entity may for example be applied using initiated chemical vapour deposition (iCVD), photodeposition, ion-assisted deposition, electron beam polymerization or gamma-ray polymerisation.

Thus, a polymeric functional entity may be applied to the surface of the mould by contacting the surface with a functional entity precursor monomer, in an exciting medium such as a plasma, in order to cause polymerisation of the monomer and deposition of the resultant polymeric functional entity onto the surface. The functional entity may therefore be applied to the surface of the mould by plasma deposition.

Plasma (or plasmachemical) deposition processes can provide a solventless approach to the preparation of well-defined polymer films; they involve the deposition of a monomer (polymer precursor) onto a substrate within a plasma, which causes the precursor molecules to polymerise as they are deposited. Plasma-activated polymer deposition processes have been widely documented in the past—see for example Yasuda, H, “Plasma Polymerization”, Academic Press: New York, 1985, and Badyal, J P S, Chemistry in Britain 37 (2001): 45-46.

A plasma deposition process may be carried out in the gas phase, typically under sub-atmospheric conditions, or on a liquid monomer or monomer-carrying vehicle as described in WO-03/101621.

In an embodiment, the functional entity is applied to the mould surface using a pulsed excitation and deposition process, ie using a pulsed exciting medium, in particular a pulsed plasma. In an embodiment, it is applied using an atomised liquid spray plasma deposition process, in which, again, the plasma may be pulsed.

Pulsed plasmachemical deposition typically entails modulating an electrical discharge on the microsecond-millisecond timescale in the presence of a suitable monomer, thereby triggering monomer activation and reactive site generation at the substrate surface (via VUV irradiation, and/or ion and/or electron bombardment) during each short (typically microsecond) duty cycle on-period. This is followed by conventional polymerisation of the monomer during each relatively long (typically millisecond) off-period. Polymerisation can thus proceed in the absence of, or at least with reduced, UV-, ion-, or electron-induced damage.

Pulsed plasma deposition can result in polymeric layers which retain a high proportion of the original functional moieties, and thus in structurally well-defined coatings.

The advantages of using (pulsed) plasma deposition, in order to deposit the functional entity, can include the potential applicability of the technique to a wide range of substrate materials and geometries, with the resulting deposited layer conforming well to the underlying surface. The technique can provide a straightforward and effective method for functionalising solid surfaces, being a single step, solventless and substrate-independent process. The inherent reactive nature of the electrical discharge can ensure good adhesion to the substrate via free radical sites created at the interface during ignition of the exciting medium. Moreover during pulsed plasma deposition, the level of surface functionality can be tailored by adjusting the plasma duty cycle.

A polymer which has been applied to a substrate—such as a mould surface—using plasma deposition will typically exhibit good adhesion to the substrate surface: this can contribute to retention of some of the functional entity at the mould surface following step (iv) of the invented method. The applied polymer will typically form as a uniform conformal coating over the entire area of the substrate which is exposed to the relevant monomer during the deposition process, regardless of substrate geometry or surface morphology. Such a polymer will also typically exhibit a high level of structural retention of the relevant monomer, particularly when the polymer has been deposited at relatively high flow rates and/or low average powers such as can be achieved using pulsed plasma deposition or atomised liquid spray plasma deposition.

Previous examples of pulsed plasma deposited, well-defined functional films include poly(glycidyl methacrylate), poly(bromoethyl-acrylate), poly(vinyl aniline), poly(vinylbenzyl chloride), poly(allylmercaptan), poly(N-acryloylsarcosine methyl ester), poly(4-vinyl pyridine) and poly(hydroxyethyl methacrylate).

Any suitable conditions may be employed for the functional entity application step (ii) of the invented method, depending on the nature of the entity and of the coating needed on the mould surface. The step is suitably carried out in the vapour phase. By way of example, and in particular when the functional entity is applied using a pulsed exciting medium and/or when the functional entity is a polyacrylate (more particularly a fluorinated polyacrylate), one or more of the following conditions may be used:
a. a pressure of from 0.01 mbar to 1 bar, for example from 0.01 or 0.1 mbar to 1 mbar or from 0.1 to 0.5 mbar, such as about 0.2 mbar.
b. a temperature of from 0 to 300° C., for example from 10 or 15 to 70° C. or from 15 to 30° C., such as room temperature (which may be from about 18 to 25° C., such as about 20° C.).
c. a power (or in the case of a pulsed exciting medium, a peak power) of from 1 to 500 W, for example from 5 to 70 W or from 5 or 10 to 60 or 50 W, such as about 40 W.
d. in the case of a pulsed exciting medium (for example a pulsed plasma), a duty cycle on-period of from 1 to 5,000 μs, for example from 1 to 500 or from 5 to 500 or from 5 to 100 μs or from 5 to 50 μs, such as about 20 μs.
e. in the case of a pulsed exciting medium (for example a pulsed plasma), a duty cycle off-period of from 1 to 100,000 μs, for example from 10,000 to 50,000 μs or from 10,000 to 30,000 μs, such as about 20 ms.
f. in the case of a pulsed exciting medium (for example a pulsed plasma), a ratio of duty cycle on-period to off-period of from 0.0005 to 1.0, for example from 0.0005 to 0.1 or from 0.0005 to 0.01, such as about 0.001.

In the case of a pulsed exciting medium such as a pulsed plasma, conditions (d) to (f) may be particularly preferred, more particularly conditions (d) and (f). Yet more particularly, it may be preferred to use a duty cycle on-period of from 1 to 100 or from 1 to 50 μs, and/or a ratio of duty cycle on-period to off-period of from 0.0005 to 0.01.

The functional entity may be applied to the mould surface in a layer having a thickness of for example 1 nm or greater. It may be applied in a layer having a thickness of up to 500 nm, or of up to 250 or 100 nm.

The functional entity need only be applied to the part(s) of the surface of the negative mould which is or are intended to come into contact with the object as it is formed, and which has or have a topography complementary to that desired on the object relevant part(s) of the object.

The object formed in or on the negative mould carries a positive replica of the template surface. It may be produced from any suitable material which retains its shape following release from the negative mould. In an embodiment, it is formed from a castable material, which may again comprise a polymer. In an embodiment, the object is cast from an epoxy resin.

The material from which the object is formed suitably has an affinity for the functional entity, by which is meant that the two components are able to dissolve in, mix with, adhere to and/or react with one another to at least some extent. In an embodiment, the degree of affinity between the object forming material and the functional entity is greater than the strength of the inter-molecular forces within the functional entity. In an embodiment, the degree of affinity between the functional entity and the surface of the negative mould is greater than the strength of the inter-molecular forces within the functional entity.

Where the object is formed by casting, the casting process may involve introducing a castable material (or a precursor therefor, such as a monomer precursor) into or onto the mould, and then curing it. Curing may be effected using any suitable technique, of which many are known.

The castable material may be applied to a surface of the mould using a process such as plasma deposition, thermal chemical vapour deposition, initiated chemical vapour deposition (iCVD), photodeposition, ion-assisted deposition, electron beam polymerisation, gamma-ray polymerisation, solution dipping, spraying, spin-coating from solution, or target sputtering.

In an embodiment of the invention, the transfer of functional entity from the negative mould to the object surface, prior to or on release of the object from the mould, may be assisted for instance with the application of pressure, heat, an electric or magnetic field, photo-irradiation, gamma-ray curing, electron beam curing, crystallisation or a combination thereof.

The object which is produced using the method of the invention may have any desired size and shape. It may take the form of a layer (which includes a film) of the material from which it is formed, for example of a suitable castable material. It may for example take the form of a polymer layer. Such a product might be suitable and/or adapted and/or intended for subsequent application to the surface of another object in order to confer a desired functionality—such as hydrophobicity—on that surface.

Objects suitable for production using the invented method include for example optical components (including mirrors and lenses, and also including contact lenses); electronic (including micro-electronic) components; packaging components and materials; artificial body parts such as limbs and organs; and components for use as parts of such objects. By way of example, contact lenses may be produced, by means of the present invention, in a single step which both moulds and functionalises the lens surfaces, for instance with one or more coatings selected from antifouling coatings, anti-reflective coatings, antibacterial and other bioactive coatings, and combinations thereof.

According to a second aspect of the invention, there is provided an object having a functionalised surface, which object has been produced using a method according to the first aspect. In an embodiment, the object has a hydrophobic surface. In an embodiment, it has a superhydrophobic surface, which may be defined as a surface exhibiting a water contact angle greater than 150° combined with a very low (for example below 10 degrees) hysteresis value. In an embodiment, the object has an oleophobic surface. In an embodiment, it has a superoleophobic surface, which may be defined as a surface exhibiting a contact angle greater than 150° with an organic liquid, in particular an oil.

In an embodiment, the object is a cast object.

In an embodiment, the object has a biomimetic surface, ie a surface having a topography which mimics that of a natural surface such as a leaf.

A third aspect of the invention provides a product which is formed from or incorporates an object according to the second aspect.

According to a fourth aspect, the invention provides a negative mould suitable for use in steps (iii) and (iv) of a method according to the first aspect, the mould carrying a functional entity which has been applied to its surface using a deposition process which takes place in an exciting medium. The mould surface may have a topography which mimics that of a natural surface. The functional entity may comprise a hydrophobic component, and/or may act to lower the surface energy of a surface to which it is applied. The functional entity may have been applied to the mould surface by plasma deposition, more particularly by pulsed plasma deposition.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, for example for the concentration of a component or a temperature, then a range of values defined by a combination of any of the upper limits with any of the lower limits may also be implied.

In this specification, references to properties such as solubilities, liquid phases and the like are—unless stated otherwise—to properties measured under ambient conditions, ie at atmospheric pressure and at a temperature of from 18 to 25° C., for example about 20° C.

The present invention will now be further described with reference to the following non-limiting examples and the accompanying figures, of which:

FIG. 1 shows schematically a method in accordance with the invention;

FIG. 2 shows optical and SEM (scanning electron microscope) images of surfaces used and produced in Example 1 below; and

FIG. 3 shows SEM images of surfaces used and produced in Example 1.

### DETAILED DESCRIPTION

### The FIG. 1 Scheme

The scheme shown in FIG. 1 illustrates two alternative methods for producing an object having a functionalised surface of a desired topography. The method (b) depicted on the right is a cure-activated nanolayer transfer process in accordance with the invention.

A surface 1 to be replicated (in this case a natural surface such as a leaf) is used as a template for the formation of a negative mould 2. The mould is produced by forming a removable polymer layer, for example of a poly(vinylsiloxane), on the surface 1.

According to method (a), the negative mould is used to form (for example to cast) a replicate object 10 which replicates the surface topography of the template surface 1. The surface of the replicate 10 is then chemically functionalised by the application of a functional surface layer 11. For example, a hydrophobic polymer layer may be deposited onto the surface of the replicate 10, for instance using a plasma deposition technique.

Method (b), in accordance with the present invention, involves application (using an exciting medium) of a functional surface layer 20 to the replica-facing surface of the negative mould 2. Again, the surface layer 20 may comprise a hydrophobic polymer and may be deposited onto the mould for instance by plasma deposition.

Subsequently, a replicate object 21 is formed in the functionalised mould, in contact with the functional surface layer 20. When the object 21 is removed from the mould, it takes with it a thin layer 22 of functional material from the surface layer 20. The result is an object which has the desired surface topography (replicating that of the template 1) and an additional functional coating. Such a process can be used to produce objects having superhydrophobic surfaces mimicking those found in nature.

It is believed that on curing the material from which the object 21 is formed, against the functionalised negative mould, a thin layer (typically a nanolayer) of the functional material is transferred to the surface of the object as it forms. When the object is removed from the mould, it carries with it this functional surface coating, conforming exactly to the surface topography of the original template. At the same time, functional material is still left on the surface of the mould: this allows one or more further objects to be formed, and functionalised, within it in the same fashion.

### Example 1

In this example, functionalised biomimetic surfaces were produced using a method in accordance with the invention.

### 1 Surface Replica Fabrication

Corydalis elata plant leaves and Attacus Atlas moth wings were selected as natural templates for this study, with the aim of replicating their natural superhydrophobicity on synthetic surfaces.

The templates were rinsed with water to remove any surface debris and allowed to dry in air. Negative moulds of the rinsed surfaces were prepared by application of a polyvinylsiloxane base and cure mixture (President Plus Jet Light Body, Coltene/Whaledent AG) to the substrate [25, 29] and immediately pressing down using a glass slide for a cure period of 10 minutes.

Once a negative mould had hardened, it was carefully peeled away from the natural substrate surface, rinsed with water and left to dry. Positive replicas were then prepared from the negative moulds using epoxy resin (epoxy resin L and hardener S, R&G Faserverbundwerkstoffe GmbH). The epoxy resin was thoroughly mixed in a 5:2 ratio of resin to hardener, and then poured over the negative mould. Any trapped air bubbles were removed by placing under vacuum, and then the mixture was left to cure overnight in a desiccator. Finally, the negative moulds were gently peeled away to reveal the positive replica of the natural substrate.

For the products prepared according to the present invention, by cure-activated nanolayer transfer, a functional coating was plasma deposited onto the negative mould prior to the application of epoxy resin to produce the positive replica.

### 2 Functional Nanocoating Deposition

Pulsed plasma deposition of the low surface energy precursor, 1H,1H,2H,2H-perfluorooctyl acrylate (+95%, Fluorochem Ltd, purified using several freeze-pump-thaw cycles) was carried out in an electrode-less cylindrical glass reactor (5 cm diameter, 520 cm³ volume, base pressure of 1×10⁻³ mbar, and with a leak rate better than 1.8×10⁻⁹ kg s⁻¹) enclosed in a Faraday cage. The chamber was fitted with a gas inlet, a Pirani pressure gauge, a 30 L min⁻¹ two-stage rotary pump attached to a liquid cold trap, and an externally wound copper coil (4 mm diameter, 9 turns, spanning 8-15 cm from the precursor inlet). All joints were grease free.

An L-C network was used to match the output impedance of a 13.56 MHz radio frequency (RF) power generator to the partially ionised gas load. The RF power supply was triggered by a signal generator and the pulse shape monitored with an oscilloscope. Prior to each experiment, the reactor chamber was cleaned by scrubbing with detergent, rinsing in water and propan-2-ol, and then oven drying. The system was then reassembled and evacuated. Further cleaning consisted of running an air plasma at 0.2 mbar pressure and 50 W power for 30 minutes.

Next, epoxy resin positive replicas, polyvinylsiloxane negative moulds, and control silicon (100) wafer (MEMC Materials Inc) and glass slides (VWR International LLC) were inserted into the centre of the reactor, and the chamber pumped back down to base pressure. At this stage, 1H,1H,2H,2H-perfluorooctyl acrylate monomer vapour was introduced at a pressure of 0.2 mbar for 5 minutes prior to ignition of the electrical discharge. The optimum conditions for functional group retention corresponded to a peak power of 40 W, a duty cycle on-time of 20 μs and an off-time of 20 ms. Deposition was allowed to proceed for 5 minutes to yield 50±5 nm thick layers. Upon plasma extinction, the precursor vapour continued to pass through the system for a further 3 minutes, and then the chamber was evacuated back down to base pressure.

### 3 Surface Characterisation

Leaf samples for scanning electron microscopy (SEM) analysis were fixed overnight in 2% gluteraldehyde in phosphate buffer solution (pH 7.4, Sigma). The leaves were then rinsed twice with buffer solution before undergoing dehydration through a graded series of ethanol solutions. The drying process was completed using a critical point dryer (Samdri 780). Dried leaf, moth wing, and epoxy resin positive replica samples were mounted onto aluminium stubs using carbon discs and coated with a 15 nm gold layer (Polaron SEM Coating Unit). Surface topography images were taken with a scanning electron microscope (Cambridge Stereoscan 240).

Advancing and receding liquid contact angle measurements were made by increasing or decreasing the liquid drop volume at the surface whilst observing using a video capture system (VCA 2500XE) [30]. The test liquid employed was high purity water (ISO 3696 Grade 1).

X-ray photoelectron spectroscopy (XPS) surface characterisation was carried out using an electron spectrometer (VG ESCALAB MKII), equipped with a non-monochromated Mg Kα_{1,2} X-ray source (1253.6 eV) and a concentric hemispherical analyser (CAE mode, pass energy=20 eV). Elemental compositions were calculated using sensitivity (multiplication) factors derived from chemical standards: C(1s):O(1s):F(1s)=1.00:0.45:0.34. All binding energies were referenced to the C(1s) hydrocarbon peak at 285.0 eV. A Marquardt minimisation computer program was used to fit core level envelopes with fixed-width-at-half-maximum (fwhm) Gaussian peak shapes [31].

Film thickness measurements were made using a spectrophotometer (nkd-6000, Aquila Instruments Ltd). Transmittance-reflectance curves, over a wavelength range of 350-1000 nm, were fitted to a Cauchy model for dielectric materials using a modified Levenberg-Maquardt method [32].

### 4 Results

### 4.1 Surface Characterisation of Natural Substrates

Corydalis elata is a perennial plant with an alternate, 2-3 ternate leaf arrangement, as seen in FIGS. 2(a) and (b). Its leaves possess a hierarchical structure consisting of microscale papillae covered by nanoscale grooves (FIGS. 2(c) and (d)). The adaxial leaf surface was found to display a high water contact angle and low hysteresis, indicative of superhydrophobic behavior (see Table 1 below).

Attacus atlas moths are documented as being one of the largest moths in the world, with an average wingspan of 24 cm [33]. Elongated scales (measuring approximately 150 μm in height and 70 μm in width) cover the wing surface and consist of several layers of chitinous material with a fine nanoscale structure, as seen by electron microscopy (FIGS. 3(a)-(c)). A large water contact angle value and low hysteresis confirmed superhydrophobicity for this natural wing surface (Table 1).

### 4.2 Epoxy Resin Replica Surfaces

Epoxy resin positive replicas of the plant leaf and moth wing surfaces were fabricated using a soft moulding process, as shown in FIG. 1. This entailed imprinting to produce a negative polyvinylsiloxane mould of the natural substrate, which itself was then moulded using epoxy resin to create a positive replica. In order to achieve individual scale replication, the negative mould was soaked in 50% HCl solution prior to creating the positive replica, in order to dissolve any natural scales that were stuck in the mould.

SEM analysis of the Corydalis elata leaf epoxy resin replicas confirmed successful duplication of the natural surface structural features (FIG. 2). However, although the surfaces displayed hydrophobicity, the contact angle hysteresis was relatively large when compared to that measured for the original leaf (Table 1).

Epoxy resin positive replicas of the Attacus atlas moth also yielded high definition replication of individual scale features, with both the micro- and nanoscale features closely resembling those seen on the native wing surface (FIG. 3). Water contact angle measurements were comparable to those of the hydrophobic Corydalis elata leaf replica, but again the large hysteresis values pointed to the absence of superhydrophobicity (Table 1).

### 4.3 Cure Activated Functional Nanolayer Transfer

50 nm thick poly(1H,1H,2H,2H-perfluorooctyl acrylate) low surface energy films were plasma deposited onto the respective negative (polyvinylsiloxane) and positive (epoxy resin) replicas depicted in FIG. 1. In the case of the former, for cure-activated nanolayer transfer, the coated negative polyvinylsiloxane mould was used to fabricate the functionalised positive epoxy resin replica.

For each type of functionalised positive replica, XPS analysis confirmed the presence of the low surface energy perfluorocarbon functionalities, and these were found to be stable towards solvent washing in propan-2-ol, methanol, acetone, dichloromethane, tetrahydrofuran, dimethylformamide, toluene and cyclohexane. Electron microscopy verified the retention of surface topography for both cases (see FIGS. 2 and 3).

Water contact angle values increased significantly compared to those of the unfunctionalised replicas, with an accompanying drop in hysteresis values (Table 1). In fact, the hysteresis values for the cure-activated nanolayer transfer replicas were much closer to those measured for the parent natural species when compared to the plasma coated positive replicas.

In the case of cure-activated nanolayer transfer, the same negative mould could be used several times to fabricate surfaces exhibiting comparable superhydrophobic properties.

### 4.4 Tables & Figures

Table 1 below shows the advancing and receding water contact angle measurements and hysteresis values for the natural surfaces and control surfaces used in Example 1, and for the functionalised surfaces generated in accordance with the invention.

TABLE 1

| | Water contact angle (°) | | |
|---|---|---|---|
| Surface | [symbol] _{Adv} | [symbol] _{Rec} | [symbol] _{Hys} |
| Untreated flat glass | 56 ± 2 | 21 ± 3 | 36 ± 1 |
| Untreated flat epoxy resin | 84 ± 2 | 34 ± 1 | 50 ± 2 |
| Plasma coated flat glass | 138 ± 2 | 93 ± 2 | 45 ± 2 |
| Corydalis elata leaf | 159 ± 1 | 158 ± 1 | 1 ± 1 |
| Untreated epoxy resin leaf replica | 136 ± 2 | 104 ± 1 | 32 ± 3 |
| Plasma coated epoxy resin leaf | 157 ± 1 | 147 ± 3 | 10 ± 3 |
| replica | | | |
| Epoxy resin leaf replica with | 158 ± 2 | 157 ± 2 | 1 ± 1 |
| cure-activated nano layer transfer | | | |
| Attacus Atlas moth | 158 ± 2 | 156 ± 2 | 2 ± 1 |
| Untreated epoxy resin moth | 140 ± 2 | 83 ± 4 | 57 ± 3 |
| replica | | | |
| Epoxy resin moth replica with | 152 ± 1 | 149 ± 2 | 4 ± 2 |
| cure-activated nano layer transfer | | | |

Table 2 shows theoretical and experimental XPS elemental compositions of the poly(1H,1H,2H,2H-perfluorooctyl acrylate) functional nanolayers applied in Example 1.

TABLE 2

| Surface | % C | % O | % F |
|---|---|---|---|
| Theoretical | 42.3 | 7.7 | 50.0 |
| Plasmachemical deposition onto | | | |
| positive replica | 39.1 ± 0.7 | 7.0 ± 0.3 | 53.9 ± 0.9 |
| Cure-activated nanolayer transfer | | | |
| onto positive replica | 40.1 ± 0.6 | 7.9 ± 0.5 | 52.0 ± 1.0 |

FIGS. 2(a) and (b) are optical images of Corydalis elata, showing, respectively, the plant and a single leaf. FIGS. 2(c) to (j) are SEM micrographs of the adaxial surface of Corydalis elata at low and high magnifications, in which (c) and (d) show the native leaf; (e) and (f) the epoxy resin replica of the leaf; (g) and (h) the epoxy resin replica functionalised via cure-activated film transfer; and (i) and (j) the epoxy resin replica functionalised via direct plasma deposition.

FIG. 3 shows SEM micrographs of the Attacus atlas moth wing surface at three different magnifications. Figures (a) to (c) show the native wing; (d) to (f) the epoxy resin positive replica; and (g) to (i) the epoxy resin replica functionalised via cure-activated nano layer transfer.

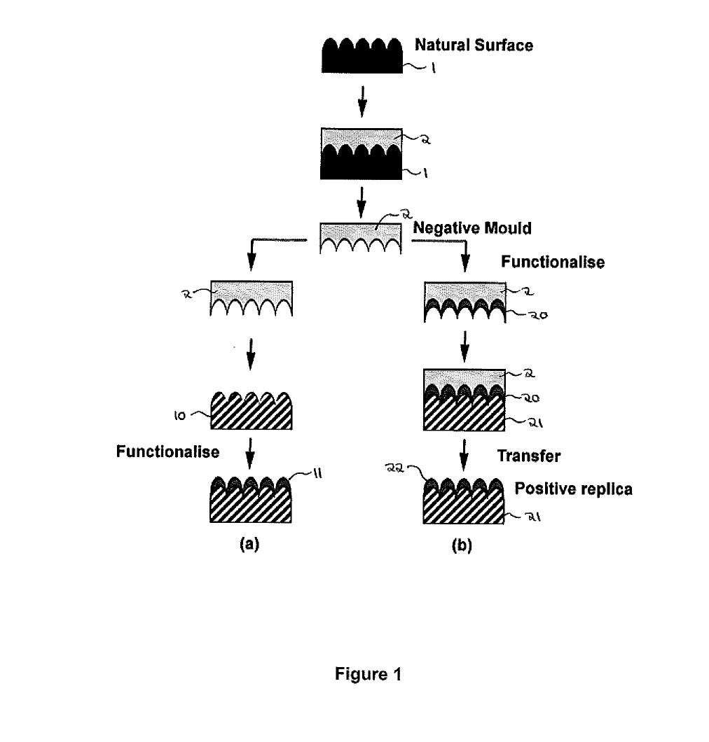

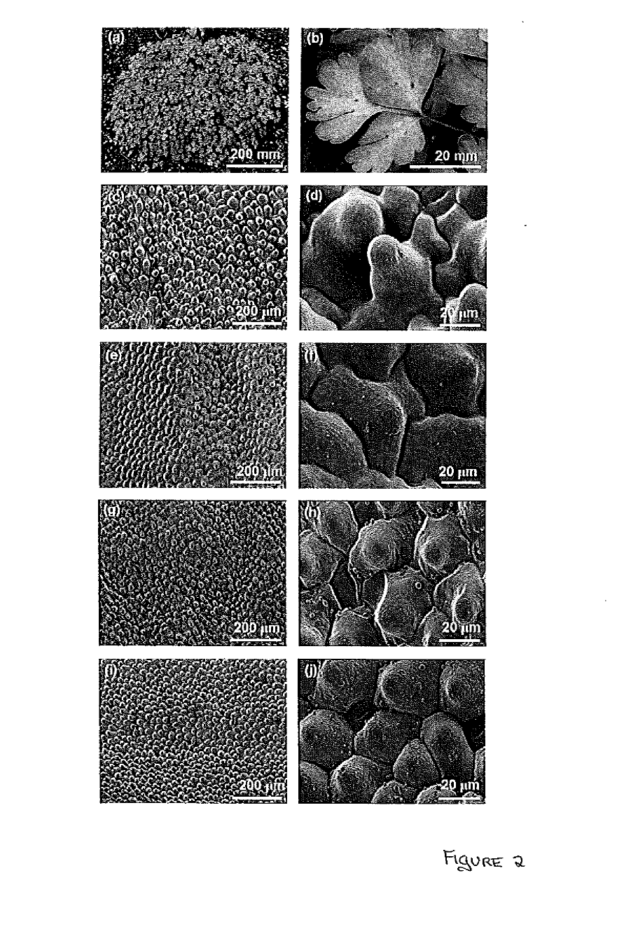

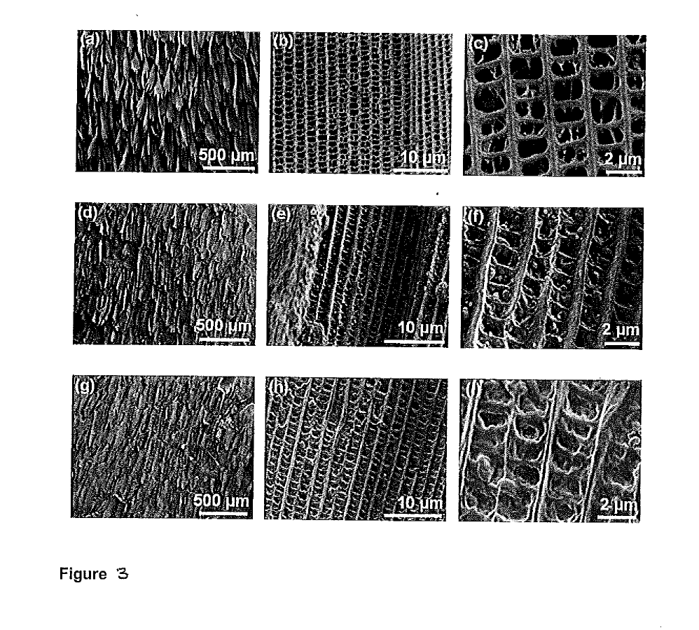

### Discussion of the Example

This example demonstrates the successful synthesis of biomimetic, superhydrophobic surfaces, using the method of the present invention. The inherent simplicity and nanoscale precision of this approach can make it highly attractive for a wide range of surface functionalisation and patterning applications.

The replica surfaces fabricated in this study display an overall retention of the fine structure contained in the original natural template surface, which is consistent with the application of this replica moulding technique to other natural surfaces [25, 29]. The key advantage of the present invention is that it can avoid the long processing times and/or high temperatures associated with alternative methods [17, 28, 34, 35, 36, 37, 38], where the consequent dehydration of the natural substrate tends to be an issue leading to shrinkage of the surface replica features compared to the parent natural substrate.

Furthermore, the replication of the individual scales of insect wings has not previously been achieved [35]. Rather, there has been replication of insect wings via calcination, where a wing is coated with a very thin inorganic layer (usually through atomic layer deposition [39, 40] or chemical vapour deposition [41] technologies) and subsequently fired at high temperatures to pyrolyse the natural substrate, culminating in shrinkage and deformation compared to the original structure. An aspect of the invention can therefore provide an object having a surface topography replicating that of an insect wing, in which individual scales are individually replicated, for instance as in Example 1 above. Such an object may be produced by casting in or on a negative mould as described above. Its surface may be chemically functionalised, which may be achieved by producing the object according to the method of the first aspect of the invention.

Functionalisation of positive replica surfaces, in order to lower their surface energy to create superhydrophobicity, has previously been attempted using separate post-replica formation processes such as self-assembled monolayers [28] or dip coating [29]. The present cure-activated nano layer transfer approach can provide a way of imparting permanent surface functionality during the replica fabrication stage, without the need for further process steps. This in turn can reduce the risk of subsequent damage to the cast replica.

One possible mechanism for the cure-activated nano layer transfer process demonstrated in Example 1 is that the epoxy resin impregnates or reacts with the plasma deposited perfluorocarbon film present on the negative, low adhesion polyvinylsiloxane mould surface during the cure process [42]. The resultant positive replica epoxy resin surface then becomes enriched with these interpenetrating functionalities upon peeling away from the mould surface, due to adhesion between the outermost epoxy resin surface and the transferred functional film. Thus in a method according to the invention, the (typically polymeric) material from which the object is cast may be chosen so as to have a degree of affinity with the functional entity on the mould surface.

The observation that the same negative mould can be used multiple times, to impart superhydrophobicity on sequential positive epoxy resin replicas, indicates that ultrathin layers of the plasma deposited poly(1H,1H,2H,2H-perfluorooctyl acrylate) film are transferred during each subsequent curing process.

In principle, the method of the invention can be used to introduce a range of other surface groups onto the surface of a cast object, including hydroxyl [43], carboxylic acid [44], anhydride [45], epoxide [46], furfuryl [47], amine [48], cyano [49], halide [50] and thiol[51] functionalities. Also, the method should be easily adaptable so that the soft negative mould can be surface-loaded with the functional entity by other methods, such as chemical vapour deposition, inking or dip coating.

Finally, multifunctional surface patterning can be envisaged by preparing spatially-functionalised negative moulds using conventional lithographic techniques.

### REFERENCES

[1] Buist, G. Proc. R. Soc. London 1856, 8, 520.
[2] Barthlott, W.; Neinhuis, C. Planta 1997, 202, 1.
[3] Autumn, K.; Liang, Y. A.; Hsieh, S. T.; Zesch, W.; Chan, W. P.; Kenny, T. W.; Fearing, R.; Full, R. J. Nature 2000, 405, 681.
[4] Arzt, E.; Gorb, S.; Spolenak, R. Proc. Natl. Acad. Sci. U.S.A. 2003, 100, 10603.
[5] Parker, A. R.; Lawrence, C. R. Nature 2001, 414, 33.
[6] Wilson, S. J.; Hutley, M. C. J. Mod. Opt. 1982, 29, 993.
[7] Ball, P. Nature 1999, 400, 507.
[8] Byun, D.; Hong, J.; Saputra, K.; Ko, J. H.; Lee, Y. J.; Park, H. C.; Byun, B.-K.; Lukes, J. R. J. Bionic Eng. 2009, 6, 63.
[9] Fang, Y.; Sun, G.; Wang, T.; Cong, Q.; Ren, L. Chin. Sci. Bull. 2007, 52, 711.
[10] Nosonovsky, M.; Bhushan, B. J. Phys. Condens. Matt. 2008, 20, 395005.
[11] Feng, X.-Q.; Gao, X.; Wu, Z.; Jiang, L.; Zheng, Q.-S. Langmuir, 2007, 23, 4892.
[12] Wei, P. J.; Chen, S. C.; Lin, J. F. Langmuir 2009, 25, 1526.
[13] Goodwyn, P. P.; De Souza, E.; Fujisaki, K.; Gorb, S. Acta Biomaterialia 2008, 4, 766.
[14] Epstein, A. K.; Pokroy, B; Seminara, A.; Aizenberg, J. Proc. Natl. Acad. Sci. U.S.A. 2011, 108, 995.
[15] Cassie, A. B. D.; Baxter, S. Trans. Faraday Soc. 1944, 40, 546.
[16] Blossey, R. Nat. Mater. 2003, 2, 301.
[17] Singh, R. A.; Yoon, E-S.; Kim, H. J.; Kim, J.; Jeong, H. E.; Suh, K. Y. Mater. Sci. Eng. C 2007, 27, 875.
[18] Roach, P.; Shirtcliffe, N.J.; Newton, M. I. Soft Matter 2008, 4, 224.
[19] Watson, G. S.; Watson, J. A. Appl. Surf Sci. 2004, 235, 139.
[20] Zhang, X.; Zhao, N.; Liang, S.; Lu, X.; Li, X.; Xie, Q.; Zhang, X.; Xu, J. Adv. Mater. 2008, 20, 2938.
[21] Öner, D.; McCarthy, T. J. Langmuir 2000, 16, 7777.
[22] Geim, A. K.; Dubonos, S. V.; Grigorieva, I. V.; Novoselov, K. S.; Zhukov, A. A.; Shapoval, S. Y. Nat. Mater. 2003, 2, 461.
[23] Jeong, H. E.; Lee, J.-K.; Kim, H. N.; Moon, S. H.; Suh, K. Y. Proc. Natl. Acad. Sci. U.S.A. 2009, 106, 5639.
[24] Madou, M. Fundamentals of Microfabrication; CRC Press, Boca Raton, Fla.: 2002.
[25] Schulte, A. J.; Koch, K.; Spaeth, M.; Barthlott, W. Acta Biomaterialia 2009, 5, 1848.
[26] Michielsen, S.; Lee, H. J. Langmuir 2007, 23, 6004.
[27] Ghosh, N.; Bajoria, A.; Vaidya, A. A. ACS Appl. Mater. Interfaces 2009, 1, 2636.
[28] Lo\check{s}ić, D. J. Serb. Chem. Soc. 2008, 73, 1123.
[29] Koch, K.; Schulte, A. J.; Fischer, A.; Gorb, S, N.; Barthlott, W. Bioinsp. Biomim. 2008, 3, 046002.
[30] Johnson, R. E.; Dettre, R. H. In Wettability; Berg, J. C., Ed.; Marcel Dekker: New York, 1993; Chapter 1, p 13.
[31] Evans, J. F.; Gibson, J. H.; Moulder, J. F.; Hammond, J. S.; Goretzki, H. Fresenius' J. Anal. Chem. 1984, 319, 841.
[32] Gauthier-Manuel, B. Meas. Sci. Technol. 1998, 9, 485.
[33] Gullan, P. J.; Cranston, P. S. The Insects: An Outline of Entomology; Blackwell Science, Oxford: 2000.
[34] Sun, M.; Luo, C.; Xu, L.; Ji, H.; Ouyang, Q.; Yu, D.; Chen, Y. Langmuir 2005, 21, 8978.
[35] Saison, T.; Peroz, C.; Chauveau, V.; Berthier, S.; Sondergard, E.; Arribart, H. Bioinsp. Biomim. 2008, 3, 046004.
[36] Lee, S.-M.; Lee, H. S.; Kim, D. S.; Kwon, T. H. Surf. Coat. Technol. 2006, 201, 553.
[37] Lee, S.-M.; Kwon, T. H. Nanotechnology 2006, 17, 3189.
[38] Lee, S.-M.; Kwon, T. H. J. Micromech. Microeng. 2007, 17, 687.
[39] Huang, J.; Wang, X.; Wang, Z. L. Nano Lett. 2006, 6, 2325.
[40] Gaillot, D. P.; Deparis, O.; Welch, V.; Wagner, B. K.; Vigneron, J. P.; Summers, C. J. Phys. Rev. E 2008, 78, 031922.
[41] Cook, G.; Timms, P. L.; Göltner-Spickermann, C. Angew. Chemie Int. Ed. 2003, 42, 557.
[42] Chihani, T.; Bergmark, P.; Flodin, P.; Hjertberg, T. J. Adhes. Sci. Technol. 1993, 7, 569.
[43] Tarducci, C.; Schofield, W. C. E.; Brewer, S. A.; Willis, C.; Badyal, J. P. S. Chem. Mater. 2002, 14, 2541.
[44] Hutton, S. J.; Crowther, J. M.; Badyal, J. P. S. Chem. Mater. 2000, 12, 2282.
[45] Ryan, M. E.; Hynes, A. M.; Badyal, J. P. S. Chem. Mater. 1996, 8, 37.
[46] Tarducci, C.; Kinmond, E. J.; Brewer, S. A.; Willis, C.; Badyal, J. P. S. Chem. Mater. 2000, 12, 1884.
[47] Tarducci, C.; Brewer, S. A.; Willis, C.; Badyal, J. P. S. Chem. Commun. 2005, 406.
[48] Harris, L. G.; Schofield, W. C. E.; Doores, K. J.; Davis, B. G.; Badyal, J. P. S. J. Am. Chem. Soc. 2009, 131, 7755.
[49] Tarducci, C.; Schofield, W. C. E.; Brewer, S. A.; Willis, C.; Badyal, J. P. S. Chem. Mater. 2001, 13, 1800.
[50] Teare, D. O. H.; Barwick, D. C.; Schofield, W. C. E.; Garrod, R. P.; Ward, L. J.; Badyal, J. P. S. Langmuir 2005, 21, 11425.
[51] Schofield, W. C. E.; McGettrick, J.; Bradley, T. J.; Badyal, J. P. S.; Przyborski, S. J. Am. Chem. Soc. 2006, 128, 2280.

1. A method for producing a surface-functionalised object from a mould, the method involving:
(i) providing a negative mould with a surface topography complementary to that desired on the object;
(ii) applying a functional entity to the surface of the negative mould, using a deposition process which takes place in an exciting medium;
(iii) forming the object in or on the negative mould, the object being in direct contact, as it forms, with the functional entity at the mould surface; and
(iv) releasing the object from the mould,
wherein during steps (iii) and/or (iv), at least some of the functional entity is transferred from the surface of the mould to the surface of the object, and further wherein a proportion of the functional entity remains on the mould surface following release of the object in step (iv).

2. A method according to claim 1, wherein in step (ii), the functional entity is applied to the surface of the mould by plasma deposition, in particular a pulsed plasma deposition process.

3. A method according to claim 1, wherein at least a surface of the negative mould is produced from a template surface which is a natural surface.

4. A method according to claim 1, wherein the functional entity imparts to the object surface a property selected from liquid repellency, hydrophilicity, increased or reduced permeability to liquids and/or gases, bioactivity, increased or reduced chemical or biochemical reactivity, increased or reduced adhesion, protein resistance, specific binding affinity, antifouling properties, antimicrobial activity, catalytic activity, the addition of guest-host complexes or other forms of encapsulating entities, the addition of sensors, and combinations thereof.

5. A method according to claim 1, wherein the functional entity comprises a hydrophobic component, and/or acts to lower the surface energy of a surface to which it is applied.

6. A method according to claim 1, wherein the functional entity is a polymer.

7. A method according to claim 6, wherein the functional entity is a fluorinated polyacrylate.

8. A method according to claim 1, wherein the object is cast in or on the mould from a castable material.

9. A method according to claim 1, wherein the transfer of functional entity from the negative mould to the object surface, prior to or on release of the object from the mould, is assisted with the application of pressure, heat, an electric or magnetic field, photo-irradiation, gamma-ray curing, electron beam curing, crystallisation, or a combination thereof.

10. A method according to claim 1, wherein steps (iii) and (iv) are repeated more than once, in succession.

11. A method according to claim 10, wherein step (ii) is not repeated between the two or more successive repetitions of steps (iii) and (iv).

12. An object having a functionalised surface, which object has been produced using a method according to claim 1.

13. An object according to claim 12, wherein the object has a hydrophobic, superhydrophobic, oleophobic or superoleophobic surface.

14. A product which is formed from or incorporates an object according to claim 12.

15. A negative mould suitable for use in steps (iii) and (iv) of a method according to claim 1, the mould carrying a functional entity which has been applied to its surface using a deposition process which takes place in an exciting medium.
